(19) United States
(12) Patent Application Publication
(10) Pub. No.: US 2005/0138156 A1
(43) Pub. Date: Jun. 23, 2005

(54) Grid application customization

(76) Inventors: Alexander Gebhart, Bad Schoenbom (DE); Erol Bozak, Pforzheim (DE)

Correspondence Address: FISH & RICHARDSON, P.C., PO BOX 1022, MINNEAPOLIS, MN, 55440-1022, US

(21) Appl. No.: 10/742,655

(22) Filed: Dec. 19, 2003

(51) Int. Cl. G06F 15/173

(52) U.S. Cl. 709/223

(57) ABSTRACT

A system and a method includes generating customization settings for an application on a first grid system, the customization settings enabling grid operation of the application. The system and method also includes distributing the application along with the customization settings to a second grid system, and installing the application and the customization settings on the second grid system such that computational resources of the second grid system can be allocated to the application from another grid system.

### TECHNICAL FIELD

The present invention relates to data processing by digital computer, and more particularly to grid application customization.

### BACKGROUND

In today's data centers, the clusters of servers in a client-server network that run business applications often do a poor job of managing unpredictable workloads. One server may sit idle, while another is constrained. This leads to a “Catch-22” where companies, needing to avoid network bottlenecks and safeguard connectivity with customers, business partners and employees, often plan for the highest spikes in workload demand, and watch as those surplus servers operate well under capacity most of the time.

In grid computing, all of the disparate computers and systems in an organization or among organizations become one large, integrated computing system. That single integrated system can then handle problems and processes too large and intensive for any single computer to easily handle in an efficient manner.

More specifically, grid computing is a form of distributed system wherein computing resources are shared across networks. Grid computing enables the selection, aggregation, and sharing of information resources resident in multiple administrative domains and across geographic areas. These information resources are shared, for example, based upon their availability, capability, and cost, as well as a user's quality of service (QoS) requirements. Grid computing can mean reduced cost of ownership, aggregated and improved efficiency of computing, data, and storage resources, and enablement of virtual organizations for applications and data sharing.

### SUMMARY

In one aspect, the invention features a system and a method for generating customization settings for an application on a first grid system, the customization settings enabling grid operation of the application. The system and method also includes distributing the application along with the customization settings to a second grid system, and installing the application and the customization settings on the second grid system such that computational resources of the second grid system can be allocated to the application from another grid system.

Embodiments may include one or more of the following. The method can include testing the customized application before distributing the customized application. The method can include bundling the customized application before distributing the customized application. Distributing the customized application to the second system can include automatically deploying the customized application to the second system. Customizing an application for grid operation can include customizing the application to operate on multiple platforms.

In another aspect, the invention features a system and a method for generating customization settings for an application on a first system, the customization settings including settings for multiple platforms. The system and method also includes distributing the application and the customization settings to a second system and determining a platform of the second system. The system and method also includes installing the application and the customization settings based on the platform such that computational resources of the second grid system can be allocated to the application from another grid system.

Embodiments may include one or more of the following. The platforms can include Windows, Linux, Unix, and Mac OS, and the like. The method can include packaging the application and customization settings for the multiple platforms before distributing the customized application to a second system. Distributing the application and the customization settings to a second system can include distributing the application and a subset of the customization settings.

In another aspect, the invention features a computer program product, tangibly embodied in an information carrier, for deploying an application. The computer program product can be operable to cause a data processing apparatus to generate customization settings for an application on a first grid system, the customization settings enabling grid operation of the application. The computer program product can be operable to cause a data processing apparatus to distribute the application along with the customization settings to a second grid system, and install the application and the customization settings on the second grid system such that computational resources of the second grid system can be allocated to the application from another grid system.

Embodiments may include one or more of the following. The product can be operable to test the customized application before distributing the customized application. The product can be operable to bundle the customized application before distributing the customized application.

In another aspect, the invention features a computer program product, tangibly embodied in an information carrier, for deploying an application. The computer program product can be operable to cause a data processing apparatus to generate customization settings for an application on a first system, the customization settings including settings for multiple platforms, distribute the application and the customization settings to a second system. The computer program product can be operable to cause a data processing apparatus to determine a platform of the second system, and install the application and the customization settings based on the platform such that computational resources of the second grid system can be allocated to the application from another grid system.

Embodiments may include one or more of the following. The platforms can include one or more of Windows, Linux, Unix, and Mac OS. The product can be operable to package the application and customization settings for the multiple platforms before distributing the customized application to a second system.

In another aspect, the invention features a system that includes a client system residing in a grid network of interconnected grid compute devices. The system includes a means for generating customization settings for an application on a first grid system, the customization settings enabling grid operation of the application, a means for distributing the application along with the customization settings to a second grid system, and a means for installing the application and the customization settings on the second grid system such that computational resources of the second grid system can be allocated to the application from another grid system.

Embodiments may include one or more of the following. The system can include a means for testing the customized application before distributing the customized application. The means for customizing an application for grid operation can include a means for customizing the application to operate on multiple platforms.

In another aspect, the invention features a method that includes a step of generating customization settings for an application on a first grid system, the customization settings enabling grid operation of the application, a step of distributing the application along with the customization settings to a second grid system, and a step of installing the application and the customization settings on the second grid system such that computational resources of the second grid system can be allocated to the application from another grid system.

Embodiments may include one or more of the following. The method can include a step of testing the customized application before distributing the customized application. The step of customizing an application for grid operation can include a step of customizing the application to operate on multiple platforms.

These and other embodiments may have one or more of the following advantages. Applications or services can be deployed into a grid computing environment. The applications or services deployed into a grid computing network can be maintained with less effort.

An application in a grid environment is customized on a first system and the customized application is re-packaged and then deployed to other systems. This reduces the effort in defining default settings for an application on multiple systems since the user defines settings on one system and the system installs and applies the settings to multiple other systems.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a grid computing environment.

FIG. 2 is a flow diagram for customizing and installing applications in the grid environment.

FIG. 3 is a block diagram of a hierarchical grid computing environment.

FIG. 4 is a block diagram of a grid computing environment.

FIG. 5 is a flow diagram for customizing and installing applications on various platforms.

### DETAILED DESCRIPTION

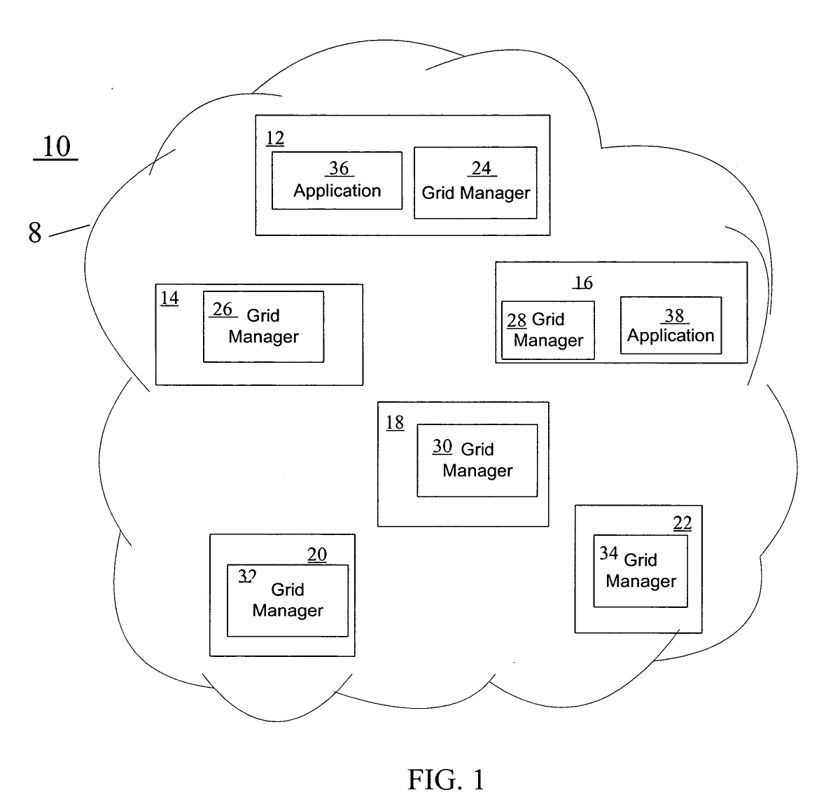

As shown in FIG. 1, grid managers 24, 26, 28, 30, 32, and 34 in a grid computing environment 10 manage computational resources for one or more applications (e.g., 36 and 38). The grid computing environment 10 includes a set of distributed computing resources that can individually be requested by the applications 36 and 38 to perform computing or data retrieval tasks for the applications 36 and 38. The grid managers 24, 26, 28, 30, 32, and 34 can be arranged in a hierarchical, linear, or some other form of architecture to coordinate handling requests by the applications. The computational resources include computer devices 12, 14, 16, 18, 20, and 22. The grid managers 24, 26, 28, 30, 32, and 34 are resident in the computer devices 12, 14, 16, 18, 20, and 22 respectively. The computer devices 12, 14, 16, 18, 20 and 22 communicate using a network 8, for example, a local area network (LAN) or a larger group of interconnected systems such as the Internet. In other cases, the computer devices 12, 14, 16, 18, 20 and 22 are single board computers and the network 8 is a data bus. The grid managers 24, 26, 28, 30, 32, and 34 facilitate installation of applications on the computer devices 12, 14, 16, 18, and 20. The grid managers 24, 26, 28, 30, 32, and 34 also manage the software components while they are present on the computer devices 12, 14, 16, 18, 20, 22, respectively. In the grid computing environment 10, the software components 36 and 38 are installed on the computer devices 14 and 16, respectively, and managed by the grid managers 24 and 28 respectively.

In some situations, a user may desire to run an application in the grid environment 10 that is not grid enabled, for example, a legacy application that was not generated with a grid environment 10 in mind. In order for this application to function in grid environment 10, a user customizes settings associated with the application. Many customization settings remain static once they are set, however, in a large grid environment customizing the application on each system to enable use of the application in the grid environment 10 requires time and effort of a user.

For example, a user might customize application 38 on computer system 16. In order to use this application on other computer devices 12, 14, 18, and 20 in the grid environment 10, grid manager 28 deploys the application and customizations to the grid environment 10 for installation on another computer system. For example, grid manager 32 can install the application and customizations on computer system 20.

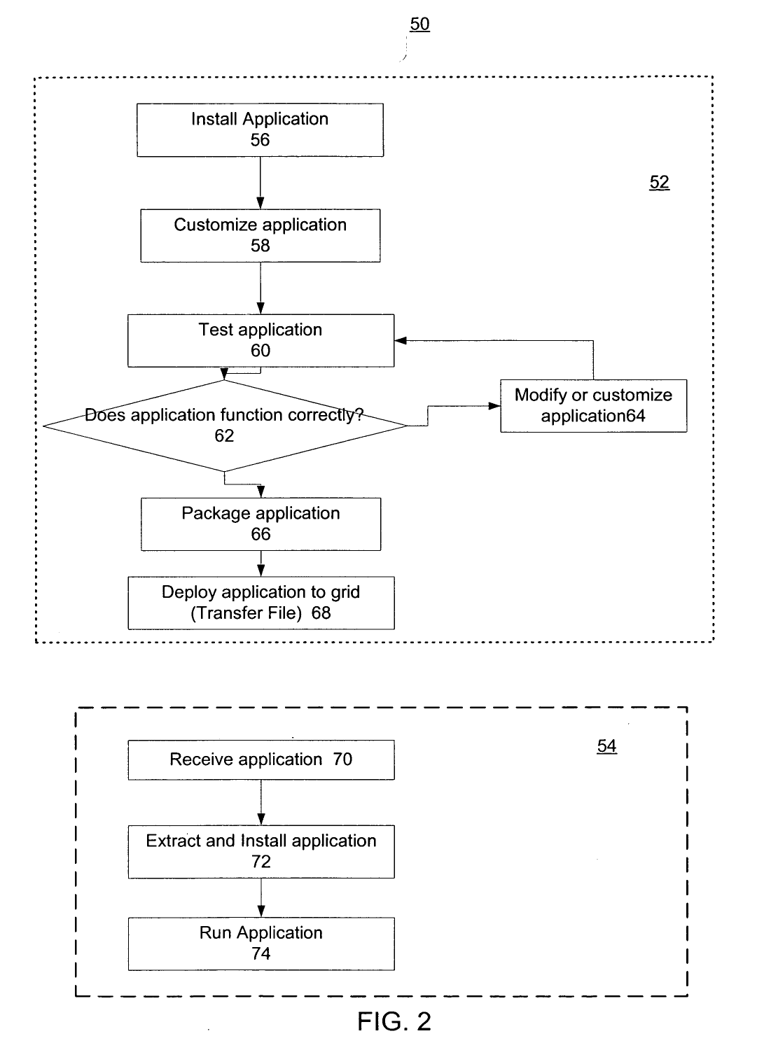

Referring to FIG. 2, a process 50 for installing applications on multiple systems in the grid environment 10 is shown. The process 50 is divided into two portions, a first portion referred to as a customization portion 52 (indicated by dotted line) and a second portion referred to as an installation portion 54 (indicated by dashed line). The division of process 50 into two portions 52 and 54 allows a user to customize and test an application on a first system, which has not necessarily be grid-enabled, (portion 52) and subsequently install the application with customizations on another system (portion 54). This division approach ensures that the application functions appropriately before deploying it in the grid environment 10. The two part approach also minimizes the effort in defining default settings for an application on multiple systems since the settings are defined by the user on one system and subsequently applied to multiple systems in the grid 10.

The customization portion 52 of process 50 includes installing 56 an application on a system. For example, a user installs 56 the application on a system without regard for operation in the grid environment. Subsequent to installing 56 the application, process 50 includes customizing 58 the application. Customizations can include settings that enable the application to operate in the grid environment. Process 50 tests 60 the application on the system. This testing ensures that the application and customizations function correctly before deploying the application to multiple other systems in the grid environment. Process 50 determines 62 if the application functions correctly and if it does not function correctly a user modifies 64 the application and customization settings. If new modifications or customizations are generated, process 50 tests 60 the application and determines 62 if the application functions correctly. The process of testing 60, determining 62, and modifying 64 repeats until process 50 determines that the application functions correctly. Subsequent to testing 60 the application and determining 62 that the application functions correctly, process 50 packages 66 the application for deployment to the grid. This packaging 66 prepares the application and customizations for delivery to other systems in the grid environment. Packaging can include compressing the files, encrypting the files, and the like. Process 50 deploys 68 the application in the grid environment. For example, the application can be transferred as a file to all systems or a subset of systems in the grid environment. Transferring can include using open grid services infrastructure (OGSI) web services description language (WSLD) interfaces on transmission control protocol (TCP), hypertext transfer protocol (HTTP), simple object access protocol (SOAP), and the like.

The second module 54 of process 50 occurs on a system that receives the application modified in the first module 52. The second module 54 of process 50 includes receiving 70 the application from another system in the grid environment (e.g., the system of part 52). Process 50 extracts and installs 72 the application. Subsequent to installation, the application runs 74 on a system in the grid environment. Thus, a user customizes an application on a first system and the first system deploys the customized application to other systems in the grid environment such that the application can be installed on the other systems and executed in the other systems of the grid environment using the customization settings defined on the first system in module 52.

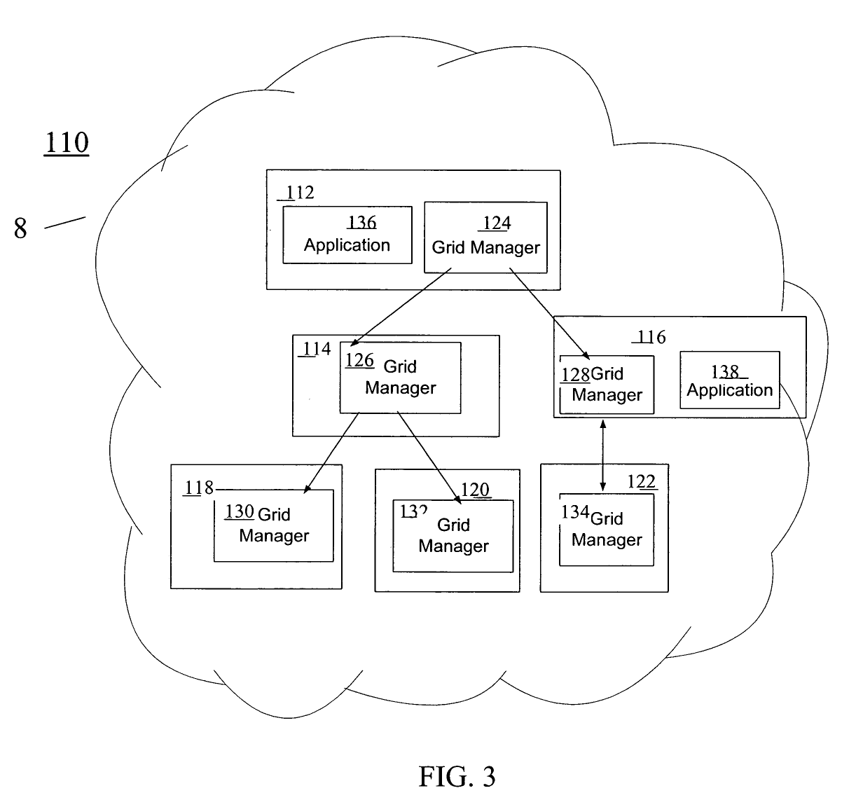

As shown in FIG. 3, one example of a grid environment is a grid computing environment 110 having a hierarchical grid management architecture. The grid computing environment 110 is a set of distributed computing resources that can individually be assigned to perform computing or data retrieval tasks for the applications. The computational resources include computer devices 112, 114, 116, 118, 120, and 122 that communicate within a network 108. Each computing device 112, 114, 116, 118, 120, and 122 includes a grid manager 124, 126, 128, 130, 132 and 134 respectively. Computer devices 112, 114, 116, 118, 120, and 122 can also include applications, for example application 136 and application 138. Grid managers 124, 126, 128, 130, 132 and 134 are organized according to this hierarchical grad management architecture. Within the grid computing environment 110 pairs of grid managers have directional relations. The grid managers 124, 126, 128, 130, 132 and 134 communicate with services in the grid computing environment 110 so that the services can allocate and de-allocate computational resources (e.g., processors in computer devices 112, 114, 116, 118, 120, 122) based on dynamic computational requirements. The grid managers also communicate to install applications on computer devices (e.g., computer devices 112, 114, 116, 118, 120, and 122) from other computer devices in the grid.

In situations, where user desires to run an application in the grid environment 110 that is not grid enabled, the user customizes settings associated with the application. In this example, a user can customize an application on one system and distribute the customized application to another system in a superior or inferior position in the hierarchical structure. For example, an application is customized on system 112 and the customized application is sent to system 114. The customized application can also be distributed from system 114 to other systems in the hierarchical grid structure.

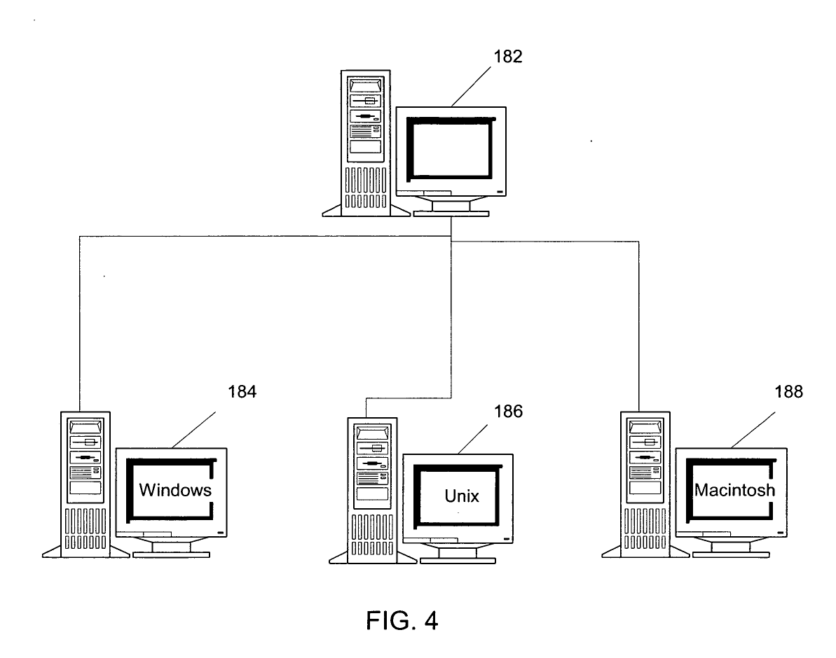

Referring to FIG. 4, an exemplary grid system 180 with four computer systems 182, 184, 186, and 188 is shown. The grid system 180 can include systems that operate on different platforms (e.g., different operating systems). When an application is customized to execute in the grid system 180, it is also customized to run on the platform of a particular system. For example, computer system 184 runs on a Windows platform and thus, applications are programmed to function in this Windows environment. System 186 on the other hand runs on a Unix operating system, thus, an application customized for the windows platform of system 184 will not function correctly on the Unix platform of system 186 without further customizations. Although customizations can differ for different systems in the grid system 180, it is often desirable to customize an application on a single system having one platform and deploy the customized application to other systems in the grid system having other platforms.

For example, the application is installed on every platform. Subsequently, a user customizes the application on only one platform to include customizations common for multiple platforms. The application is packaged to include the customized settings common for multiple platforms. Subsequently, platform specific customizations are added into the package. This allows a single package to be deployed and used by a variety of systems with different operating system platforms. The deployment can include transferring the entire package to another system, detecting the platform, and installing only the platform specific and common customizations. Alternately, the detection occurs prior to deployment of the application, and the system repackages the application to include only the common and platform specific customizations, this new package is deployed and installed on another system.

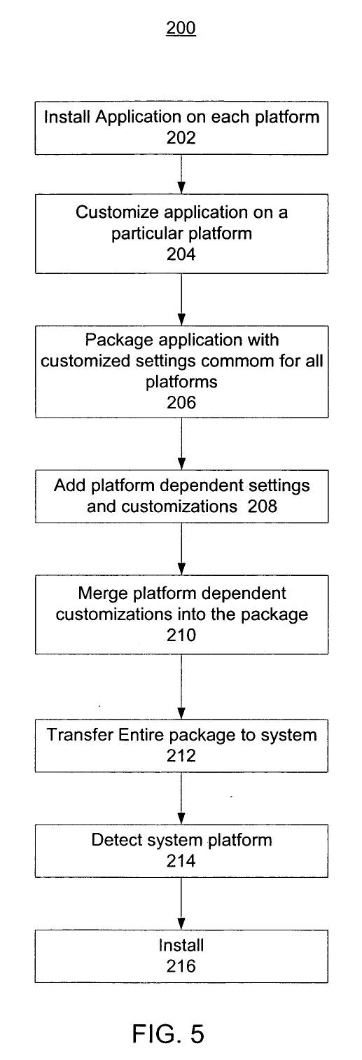

Referring to FIG. 5, a process 200 for deploying an application to multiple systems having different platforms is shown. Process 200 includes installing 202 the application on each platform and customizing 204 the application on a particular platform. Process 200 packages 206 the customized settings common for all platforms. Process 200 also adds 208 platform specific settings and customizations and merges 210 these settings into the package. Process 200 transfers the package to another system 212 and detects 214 the platform of the other system. Process 200 extracts the customization settings for the platform and installs 216 the application including the platform specific customizations on the system.

The network 8 can be implemented in a variety of ways. The network 8 includes any kind and any combination of networks such as an Internet, a local area network (LAN) or other local network, a private network, a public network, a plain old telephone system (POTS), or other similar wired or wireless networks. Communications through the network 8 may be secured with a mechanism such as encryption, a security protocol, or other type of similar mechanism. Communications through the network 8 can include any kind and any combination of communication links such as modem links, Ethernet links, cables, point-to-point links, infrared connections, fiber optic links, wireless links, cellular links, Bluetooth®, satellite links, and other similar links.

The network 8 is simplified for ease of explanation. The network 8 can include more or fewer additional elements such as networks, communication links, proxy servers, firewalls or other security mechanisms, Internet Service Providers (ISPs), gatekeepers, gateways, switches, routers, hubs, client terminals, and other elements.

Computer devices 12, 14, 16, 18, 20, and 22 communicate in the grid environment using one of many different networking protocols. For instance, one protocol is Transmission Control Protocol/Internet Protocol (TCP/IP) combined with SOAP (Simple Object Access Protocol).

Embodiments of the invention can be implemented in digital electronic circuitry, or in computer hardware, firmware, software, or in combinations of them. Embodiment of the invention can be implemented as a computer program product, i.e., a computer program tangibly embodied in an information carrier, e.g., in a node-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit):

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of embodiments of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Other embodiments are within the scope of the following claims.

1. A method comprising:
generating customization settings for an application on a first grid system, the customization settings enabling grid operation of the application;
distributing the application along with the customization settings to a second grid system; and
installing the application and the customization settings on the second grid system such that computational resources of the second grid system can be allocated to the application from another grid system.

2. The method of claim 1 further comprising testing the customized application before distributing the customized application.

3. The method of claim 1 further comprising bundling the customized application before distributing the customized application.

4. The method of claim 1 wherein distributing the customized application to the second system includes automatically deploying the customized application to the second system.

5. The method of claim 1 wherein customizing an application for grid operation includes customizing the application to operate on multiple platforms.

6. A method comprising:
generating customization settings for an application on a first system, the customization settings including settings for multiple platforms;
distributing the application and the customization settings to a second system;
determining a platform of the second system; and
installing the application and the customization settings based on the platform such that computational resources of the second grid system can be allocated to the application from another grid system.

7. The method of claim 6 wherein the platforms include one or more of Windows, Linux, Unix, and Mac OS.

8. The method of claim 6 further comprising packaging the application and customization settings for the multiple platforms before distributing the customized application to a second system

9. The method of claim 6 wherein distributing the application and the customization settings to a second system includes distributing the application and a subset of the customization settings.

10. A computer program product, tangibly embodied in a n information carrier, for deploying an application, the computer program product being operable to cause a data processing apparatus to:
generate customization settings for an application on a first grid system, the customization settings enabling grid operation of the application;
distribute the application along with the customization settings to a second grid system; and
install the application and the customization settings on the second grid system such that computational resources of the second grid system can be allocated to the application from another grid system.

11. The product of claim 10, the product being operable to test the customized application before distributing the customized application.

12. The product of claim 10, the product being operable to bundle the customized application before distributing the customized application.

13. A computer program product, tangibly embodied in a n information carrier, for deploying an application, the computer program product being operable to cause a data processing apparatus to:
generate customization settings for an application on a first system, the customization settings including settings for multiple platforms;
distribute the application and the customization settings to a second system;
determine a platform of the second system; and
install the application and the customization settings based on the platform such that computational resources of the second grid system can be allocated to the application from another grid system.

14. The product of claim 13 wherein the platforms include one or more of Windows, Linux, Unix, and Mac OS.

15. The product of claim 13, the product being operable to package the application and customization settings for the multiple platforms before distributing the customized application to a second system.

16. A system comprising:
a client system residing in a grid network of interconnected grid compute devices;
a means for generating customization settings for an application on a first grid system, the customization settings enabling grid operation of the application;
a means for distributing the application along with the customization settings to a second grid system; and
a means for installing the application and the customization settings on the second grid system such that computational resources of the second grid system can be allocated to the application from another grid system.

17. The system of claim 16 further comprising a means for testing the customized application before distributing the customized application.

18. The system of claim 16 wherein the means for customizing an application for grid operation includes a means for customizing the application to operate on multiple platforms.

19. A method comprising the steps of:
a step of generating customization settings for an application on a first grid system, the customization settings enabling grid operation of the application;
a step of distributing the application along with the customization settings to a second grid system; and
a step of installing the application and the customization settings on the second grid system such that computational resources of the second grid system can be allocated to the application from another grid system.

20. The method of claim 19 further comprising a step of testing the customized application before distributing the customized application.

21. The method of claim 19 wherein the step of customizing an application for grid operation includes a step of customizing the application to operate on multiple platforms.
